(19) United States
(12) Patent Application Publication
(10) Pub. No.: US 2022/0108273 A1
(43) Pub. Date: Apr. 7, 2022

(54) CONTROL APPARATUS, SYSTEM, AND NON-TRANSITORY COMPUTER READABLE MEDIUM

(71) Applicant: TOYOTA JIDOSHA KABUSHIKI KAISHA, Toyota-shi (JP)

(72) Inventors: Ai MIYATA, Okazaki-shi (JP); Yurika TANAKA, Yokosuka-shi (JP); Hideo HASEGAWA, Nagoya-shi (JP); Hiroyuki SUZUKI, Miyoshi-shi (JP); Katsuhiro OHARA, Nagoya-shi (JP); Tomoya MAKINO, Kariya-shi (JP)

(73) Assignee: TOYOTA JIDOSHA KABUSHIKI KAISHA, Toyota-shi (JP)

(21) Appl. No.: 17/490,249

(22) Filed: Sep. 30, 2021

(30) Foreign Application Priority Data
Oct. 1, 2020 (JP) 2020-167349

(51) Int. Cl. G06Q 10/08; G06Q 10/06; B64C 39/02; G01C 21/20; G01C 21/34; G05D 1/10; G01W 1/14

(52) U.S. Cl. CPC G06Q 10/08355; G06Q 10/06315; G06Q 10/06312; B64C 39/024; G01C 21/20; B64C 2201/208; G05D 1/1062; G01W 1/14; B64C 2201/027; B64C 2201/128; G01C 21/3423

(57) ABSTRACT

A control apparatus includes a communication interface, and a controller configured to acquire a first delivery route via an initial air delivery point at which a package is to be delivered by air transport, and an initial land transport delivery point at which a package is to be delivered by land transport, acquire weather information indicating a weather condition on the first delivery route via the communication interface, change the initial air delivery point to a modified land transport delivery point for which a delivery method of the package is switched to delivery by land transport, in accordance with the weather information, and determine a second delivery route via the initial land transport delivery point and the modified land transport delivery point.

### CROSS-REFERENCE TO RELATED APPLICATION

This application claims priority to Japanese Patent Application No. 2020-167349 filed on Oct. 1, 2020, the entire contents of which are incorporated herein by reference.

### TECHNICAL FIELD

The present disclosure relates to a control apparatus, a system, and a program.

### BACKGROUND

Technology for generating a plan for delivering a package using an unmanned aircraft, and notifying a recipient in advance of the scheduled delivery time of the package, is known. For example, Patent Literature (PTL) 1 describes technology for generating a plan for delivering a package using an unmanned aircraft, and notifying the recipient of the scheduled delivery time for the package, which is estimated based on the plan.

### CITATION LIST

### Patent Literature

PTL 1: JP 2020-070159 A

### SUMMARY

However, according to the conventional technology, situations in which weather conditions are unsuitable for the unmanned aircraft to fly are not taken into account when the plan for delivering the package is generated.

It would be helpful to make it easier to generate a delivery plan for packages using an unmanned aircraft, accounting for weather conditions.

A control apparatus according to the present disclosure includes:

a communication interface; and

a controller configured to:

acquire a first delivery route via an initial air delivery point at which a package is to be delivered by air transport, and an initial land transport delivery point at which a package is to be delivered by land transport;

acquire weather information indicating a weather condition on the first delivery route via the communication interface;

change the initial air delivery point to a modified land transport delivery point for which a delivery method of the package is switched to delivery by land transport, in accordance with the weather information; and

determine a second delivery route via the initial land transport delivery point and the modified land transport delivery point.

A system according to the present disclosure includes:

the control apparatus; and

the vehicle.

A program according to the present disclosure is configured to cause a computer comprising a communication interface to execute operations, the operations including:

acquiring a first delivery route via an initial air delivery point at which a package is to be delivered by air transport, and an initial land transport delivery point at which a package is to be delivered by land transport;

acquiring weather information indicating a weather condition on the first delivery route via the communication interface;

changing the initial air delivery point to a modified land transport delivery point for which a delivery method of the package is switched to delivery by land transport, in accordance with the weather condition; and

determining a second delivery route via the initial land transport delivery point and the modified land transport delivery point.

According to the present embodiment, generation of a delivery plan for packages using an unmanned aircraft, accounting for weather conditions, can be made easier.

### BRIEF DESCRIPTION OF THE DRAWINGS

In the accompanying drawings:

FIG. 1 is a diagram illustrating a configuration of a system according to a present disclosure;

FIG. 2 is a block diagram illustrating a configuration of a control apparatus, a terminal apparatus, and a vehicle according to the present disclosure;

FIG. 3A is a diagram illustrating an example of a first delivery plan according to the present disclosure;

FIG. 3B is a diagram illustrating an example of the first delivery plan according to the present disclosure;

FIG. 4 is a diagram illustrating an example of a first delivery route according to the present disclosure;

FIG. 5 is a diagram illustrating an example of a second delivery plan according to the present disclosure;

FIG. 6 is a diagram illustrating an example of a second delivery route according to the present disclosure;

FIG. 7A is a diagram illustrating operations of the system according to the present disclosure;

FIG. 7B is a diagram illustrating operations of the system according to the present disclosure; and

FIG. 8 is a diagram illustrating examples of screens displayed on an output interface of a terminal apparatus according to a variation.

### DETAILED DESCRIPTION

Hereinafter, an embodiment of the present disclosure will be described with reference to the drawings. In the drawings, the same or corresponding portions are denoted by the same reference numerals. In the descriptions of the present embodiment, detailed descriptions of the same or corresponding portions are omitted or simplified, as appropriate.

### First Embodiment

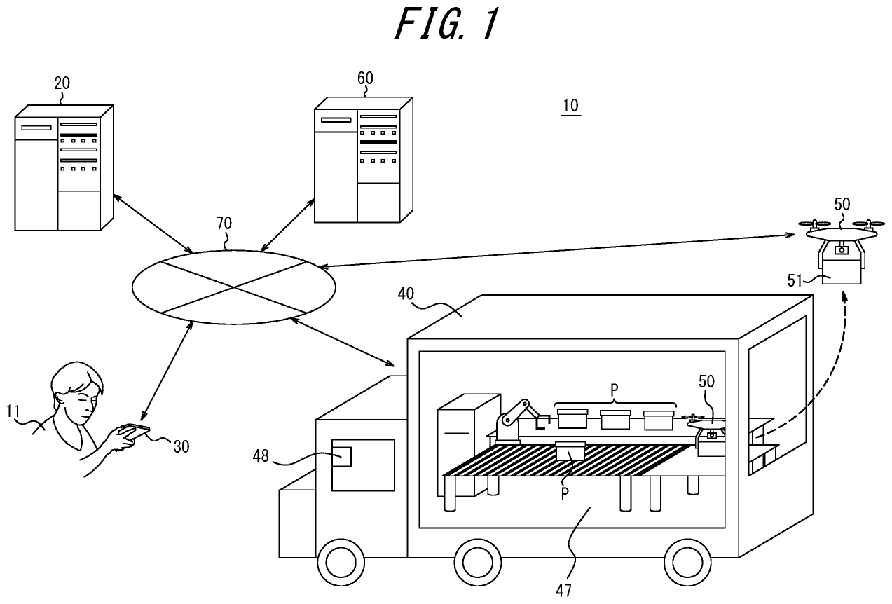

A configuration of a system 10 according to the present embodiment will be described with reference to FIG. 1.

The system 10 according to the present embodiment includes a control apparatus 20, one or more terminal apparatuses 30, one or more vehicles 40, one or more unmanned aircraft 50, and one or more information providing apparatuses 60. For convenience of explanation, FIG. 1 illustrates a single terminal apparatus 30, a single vehicle 40, and a single information providing apparatus 60, and two unmanned aircraft 50, but the numbers of the terminal apparatus 30, the vehicle 40, the unmanned aircraft 50, and the information providing apparatus 60 included in the system 10 are not limited thereto, and may be freely set.

The control apparatus 20 can communicate with the terminal apparatus 30, the vehicle 40, the unmanned aircraft 50, and the information providing apparatus 60 via a network 70.

The network 70 includes the Internet, at least one WAN, at least one MAN, or a combination thereof. The term “WAN” is an abbreviation of wide area network. The term “MAN” is an abbreviation of metropolitan area network. The network 70 may include at least one wireless network, at least one optical network, or a combination thereof. The wireless network is, for example, an ad hoc network, a cellular network, a wireless LAN, a satellite communication network, or a terrestrial microwave network. The term “LAN” is an abbreviation of local area network.

The control apparatus 20 is installed in a facility such as a data center. The control apparatus 20 is, for example, a server that belongs to a cloud computing system or another type of computing system. The control apparatus 20 is installed at any location. For example, the control apparatus 20 may be installed in an office of a courier company that provides a delivery service for packages P, or in a warehouse or the like where packages P are stored.

The terminal apparatus 30 is used by a user 11 as a recipient or a sender of a package P. The terminal apparatus 30 is, for example, a mobile device such as a mobile phone, a smartphone, a wearable device, or a tablet, or a PC. The term “PC” is an abbreviation of personal computer.

The vehicle 40 is, for example, any type of automobile such as a gasoline vehicle, a diesel vehicle, an HEV, a PHEV, a BEV, or an FCEV. The term “HEV” is an abbreviation of hybrid electric vehicle. The term “PHEV” is an abbreviation of plug-in hybrid electric vehicle. The term “BEV” is an abbreviation of battery electric vehicle. The term “FCEV” is an abbreviation of fuel cell electric vehicle. The vehicle 40 is driven by a driver in the present embodiment, but the driving may be automated at any level. The automation level is, for example, any one of Level 1 to Level 5 according to the level classification defined by the SAE. The name “SAE” is an abbreviation of the Society of Automotive Engineers. The vehicle 40 may be a MaaS-dedicated vehicle. The term “MaaS” is an abbreviation of Mobility as a Service. In the present embodiment, the vehicle 40 is used as a means for delivering packages P by land.

The unmanned aircraft 50 is an aircraft which does not have a person on board, and is also referred to as a drone or a multicopter. The unmanned aircraft 50 can be flown by remote control or can fly autonomously. The unmanned aircraft 50 includes a main body, propellers, and a motor. The unmanned aircraft 50 of the present embodiment further includes a package store 51 for storing package P. The motor increases or decreases the number of rotations of the propellers, which allows the unmanned aircraft 50 to move forward, backward, turn, hover, etc. in the air. The main body includes a controller, a memory, a communication interface, an input interface, and a positioner. The main body can also include a camera. The controller receives, via the communication interface, a first delivery plan and a first delivery route, which will be explained in detail below, from the control apparatus 20. The first delivery plan and the first delivery route may be received from the vehicle 40. The controller causes the unmanned aircraft 50 to fly autonomously based on the received first delivery plan and the first delivery route. The package store 51 has a storage space for storing a package P and a door with a lock. The package store 51 may include a plurality of storage spaces, allowing packages P for a plurality of delivery destinations to be transported at one time. The door can be unlocked by the user 11, who is the recipient of the package P, by entering a PIN (personal identification number) through the input interface of the unmanned aircraft 50. The door may also be unlocked by using the camera of the unmanned aircraft 50 to read a code for unlocking, which is displayed by the user 11 on the terminal apparatus 30. Instead of the package store 51, the unmanned aircraft 50 may include an arm configured to allow the unmanned aircraft 50 to fly while grasping the baggage P.

In the present embodiment, the unmanned aircraft 50 is used as a means for delivering packages P by air transport. The unmanned aircraft 50 is loaded onto the vehicle 40 and transported to a specific point S where air transport is to be started. Upon arriving at point S, the unmanned aircraft 50 departs from the vehicle 40 with a package P stored in the package store 51, and delivers the package P to an initial air transport delivery point included in a first delivery plan. The vehicle 40 also departs from point S and carries out land transportation of packages P via an initial land transport delivery point. Upon completion of the delivery, the unmanned aircraft 50 acquires positional information indicating a current position of the vehicle 40 via the communication interface, and can fly autonomously back to the position of the vehicle 40 based on the positional information. A single unmanned aircraft 50 may deliver each of a plurality of packages P to each of a plurality of delivery points, or each of a plurality of the unmanned aircraft 50 may depart from the vehicle 40 and deliver each of the plurality of packages P to each of the different delivery points.

The information providing apparatus 60 is installed in a meteorological observation center that observes the meteorology in various regions. The information providing apparatus 60 is, for example, a server that belongs to a crowd computing system or other computing systems. The information providing apparatus 60 includes a controller, a memory and a communication interface. The memory of the information providing apparatus 60 stores meteorology information for various locations acquired in real time by the controller. The meteorology information includes information on wind speed, rainfall amount, or the like. In response to a request from the control apparatus 20, the controller of the information providing apparatus 60 reads, as weather information, meteorology information for a first delivery route among meteorology information for various locations stored in the memory. The controller of the information providing apparatus 60 transmits the weather information read via the communication interface to the control apparatus 20.

An outline of the present embodiment will be described with reference to FIG. 1.

In the system 10 illustrated in FIG. 1, the control apparatus 20 acquires a first delivery route via an initial air transport delivery point, which is a point where a package P is to be delivered by air transport, and an initial land transport delivery point, which is a point where a package P is to be delivered by land transport. The control apparatus 20 acquires weather information indicating weather conditions for the first delivery route. Depending on the weather information, the control apparatus 20 changes the initial air transport delivery point to a modified land transport delivery point, wherein the delivery method of package P is switched to land transport, and determines a second delivery route via the initial land transport delivery point and the modified land transport delivery point. Air transport is carried out using the unmanned aircraft 50, and land transport is carried out using the vehicle 40 that is loaded with the unmanned aircraft 50. The weather information includes rainfall amount, and the control apparatus 20 changes the initial air transport delivery point to a modified land transport delivery point, when the rainfall amount is equal to or greater than a reference value.

The “initial air transport delivery point” is a delivery point included in a first delivery plan, to which the package P is to be delivered by air transport. The “first delivery plan” includes information used to deliver packages P, such as information on the delivery points, the traveling order for each of the delivery points, methods of delivery, types of the delivery points, scheduled delivery dates, scheduled delivery times, and the like. The term “method of delivery” includes land transport or air transport. The method of delivery is not limited to this, but includes any method such as a maritime transport. The first delivery plan is generated by the control apparatus 20 as will be described in detail below, and is used to generate a first delivery route. The “first delivery route” is a route on a map that the vehicle 40 or the unmanned aircraft 50 travels in order to deliver packages P to each delivery point. The first delivery route is determined by the control apparatus 20 based on the first delivery plan. The “initial land transport delivery point” is a delivery point included in the first delivery plan, where a package P is to be delivered by land transport. The initial land transport delivery point can also be included in a second delivery plan. The initial land transport delivery point included in the second delivery plan refers to the delivery point where the method of delivery is unchanged from the first delivery plan and remains land transport. The “modified land transport delivery point” refers to a delivery point where the method of delivery is has been changed from air transport to land transport. The modified land transport delivery point can be included in the second delivery plan. In a similar manner to the first delivery plan, the “second delivery plan” includes information used to deliver packages P, such as information on the delivery points, the order in which each of the delivery points is to be traveled, a method of delivery, a scheduled delivery date, scheduled delivery times, and the like. The second delivery plan is generated by the control apparatus 20 when the control apparatus 20 determines to change the initial air transport delivery point to the modified land transport delivery point, depending on the weather information acquired, as will be described in more detail below. The second delivery plan is used to generate a second delivery route. The “second delivery route” is a route on the map that the vehicle 40 travels in order to deliver packages P to each delivery point. The second delivery route is determined by the control apparatus 20 based on the second delivery plan. The “weather information” is information indicating the weather conditions at the delivery point included in the first delivery route and on the route to the delivery point. Weather information specifically includes rainfall amount, but the weather information may include snowfall, wind direction, wind speed, temperature or the like, without being limited thereto. Weather information is acquired by the control apparatus 20 from the information providing apparatus 60 or the vehicle 40, as will be described in more detail below. The “reference value” is a value of weather information for which delivery by air transport is difficult, and may be freely set depending on the performance or the like, of the unmanned aircraft 50. For example, in a case in which the weather information refers to rainfall amount, the reference value is a value of 5 mm per hour of rainfall. For example, in a case in which the weather information refers to wind speed, the reference value is a value of 10 m/s of wind speed. The control apparatus 20 determines whether the acquired weather information indicates a value that is equal to or greater than the reference value, and determines to change the initial air transport delivery point to the modified land transport delivery point, when the value is equal to or greater than the reference value.

According to the present embodiment, it becomes easier to generate a delivery plan for packages using the unmanned aircraft, accounting for weather conditions.

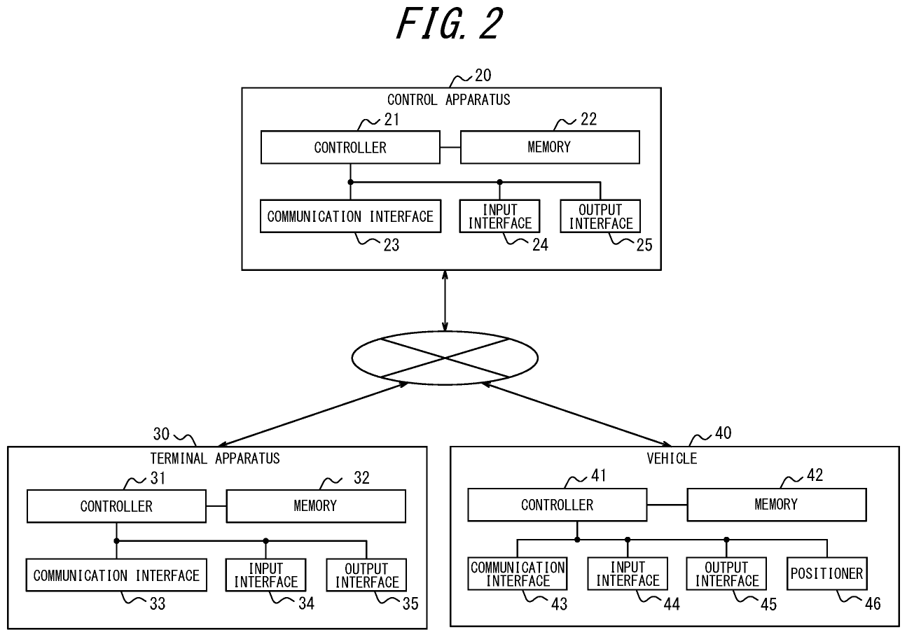

A configuration of the control apparatus 20 according to the present embodiment will be described with reference to FIG. 2. The control apparatus 20 includes a controller 21, a memory 22, a communication interface 23, an input interface 24, and an output interface 25.

The controller 21 includes at least one processor, at least one dedicated circuit, or a combination thereof. The processor is a general purpose processor such as a CPU or a GPU, or a dedicated processor that is dedicated to specific processing. The term “CPU” is an abbreviation of central processing unit. The term “GPU” is an abbreviation of graphics processing unit. The dedicated circuit is, for example, an FPGA or an ASIC. The term “FPGA” is an abbreviation of field-programmable gate array. The term “ASIC” is an abbreviation of application specific integrated circuit. The controller 21 executes processes related to operations of the control apparatus 20 while controlling each component of the control apparatus 20. The controller 21 generates the first delivery plan and determines the first delivery route based on the first delivery plan, as will be described in detail below. The controller 21 also generates the second delivery plan and determines the second delivery route based on the second delivery plan, as will be described in detail below.

The communication interface 23 includes at least one interface for communication. The interface for communication is, for example, a LAN interface. The communication interface 23 receives information for use in operations of the control apparatus 20, or transmits information resulting from operations of the control apparatus 20.

The input interface 24 includes at least one interface for input. The interface for input is, for example, a physical key, a capacitive key, a pointing device, a touch screen integrally provided with a display, or a microphone. The input interface 24 receives a manipulation to input information for use in operations of the control apparatus 20. The input interface 24, instead of being included in the control apparatus 20, may be connected to the control apparatus 20 as an external input device. As the connection method, any technology such as USB, HDMI® (HDMI is a registered trademark in Japan, other countries, or both), or Bluetooth® (Bluetooth is a registered trademark in Japan, other countries, or both) can be used. The term “USB” is an abbreviation of Universal Serial Bus. The term “HDMI®” is an abbreviation of High-Definition Multimedia Interface. The input interface 24 may directly accept input of information on the first delivery plan, the first delivery route, the second delivery plan, and the second delivery route from a member of staff at the office of the courier company, or from a member of staff at the warehouse where package P is stored.

The output interface 25 includes at least one interface for output. The interface for output is, for example, a display or a speaker. The display is, for example, an LCD or an organic EL display. The term “LCD” is an abbreviation of liquid crystal display. The term “EL” is an abbreviation of electro luminescence. The output interface 25 outputs information resulting from operations of the control apparatus 20. The output interface 25, instead of being included in the control apparatus 20, may be connected to the control apparatus 20 as an external output device. As the connection method, any technology such as USB, HDMI®, or Bluetooth® can be used.

The memory 22 includes at least one semiconductor memory, at least one magnetic memory, at least one optical memory, or a combination of at least two of these. The semiconductor memory is, for example, RAM or ROM. The term “RAM” is an abbreviation of random access memory. The term “ROM” is an abbreviation of read only memory. The RAM is, for example, SRAM or DRAM. The term “SRAM” is an abbreviation of static random access memory. The term “DRAM” is an abbreviation of dynamic random access memory. The ROM is, for example, EEPROM. The term “EEPROM” is an abbreviation of electrically erasable programmable read only memory. The memory 22 functions as, for example, a main memory, an auxiliary memory, or a cache memory. The memory 22 stores information for use in operations of the control apparatus 20 and information resulting from operations of the control apparatus 20. The memory 22 stores a system program, an application program, map information, the reference values for weather information, the first delivery plan, the first delivery route, the second delivery plan, the second delivery route, and a reference time.

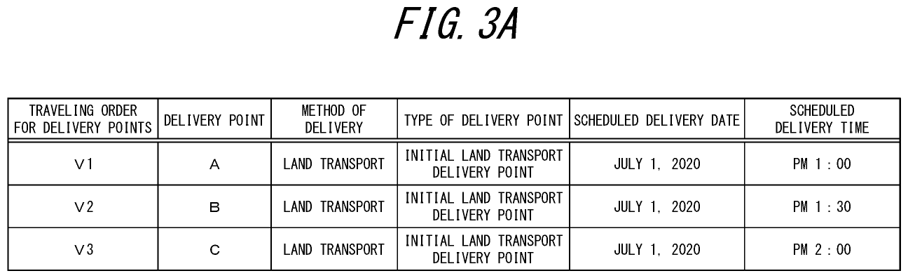

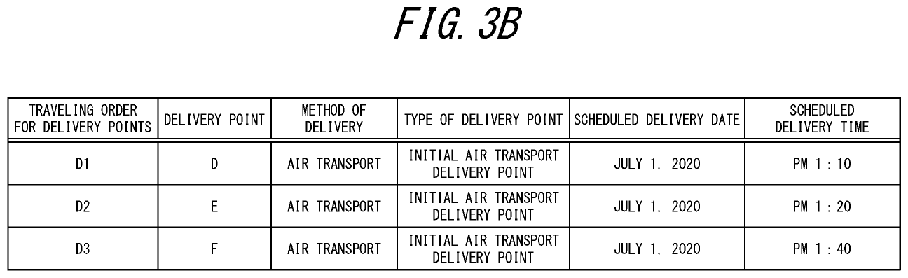

Examples of the first delivery plan are illustrated in FIGS. 3A and 3B. FIG. 3A illustrates, in a table form, the traveling order for each of the delivery points, the delivery points, the methods of delivery, the types of the delivery points, the scheduled delivery dates, and the scheduled delivery times, for the vehicle 40 to deliver packages P. FIG. 3B illustrates, in a table form, the traveling order for each of the delivery points, the delivery points, the methods of delivery, the types of the delivery points, the scheduled delivery dates, and the scheduled delivery times, for the unmanned aircraft 50 loaded onto the vehicle 40 to deliver packages P. In the present embodiment, among the information included in the first delivery plan, the delivery points, the scheduled delivery dates, and the scheduled delivery times may be set, reflecting a request from the user 11 who is the recipient or the sender of a package P. Specifically, the user 11 may input a request for the scheduled delivery date or the like to the terminal apparatus 30, the terminal apparatus 30 transmits information on the input request to the control apparatus 20, and the control apparatus 20 receives the information to thereby set the scheduled delivery date or the like. The types of the delivery points are set by the controller 21 based on the method of delivery. The traveling order for each of the delivery points is set by the controller 21, as will be described in detail below. The method of delivery may be set based on the request of the user 11, or the controller 21 may set the method of delivery as appropriate with reference to the map information. For example, the controller 21 may set the delivery method as air transport using the unmanned aircraft 50, when the delivery point is located away from a road through which the vehicle 40 can pass.

The traveling orders of the delivery points in FIGS. 3A and 3B illustrate the order in which the delivery points are to be traveled by each of the vehicle 40 and the unmanned aircraft 50 when delivering packages P. The traveling order of the delivery points is, for example, the order in which each of the delivery points can be traveled in the shortest distance. With reference to FIG. 3A, for example, a delivery point A corresponding to V1 in the traveling order is the delivery point to which the vehicle 40 travels first. The scheduled delivery date for delivery point A is Jul. 1, 2020, and the scheduled delivery time is 1:00 p.m. Delivery point B corresponding to V2 in the traveling order is the delivery point to which the vehicle 40 travels second, and the scheduled delivery date for delivery point B is Jul. 1, 2020, and the scheduled delivery time is 1:30 p.m. Similarly in FIG. 3B, delivery point D corresponding to D1 in the traveling order is the delivery point to which the unmanned aircraft 50 travels first. The scheduled delivery date for delivery point D is Jul. 1, 2020, and the scheduled delivery time is 1:10 p.m. Delivery point E corresponding to D2 in the traveling order is the delivery point to which the unmanned aircraft 50 travels second, and the scheduled delivery date is Jul. 1, 2020, and the scheduled delivery time is 1:20 p.m.

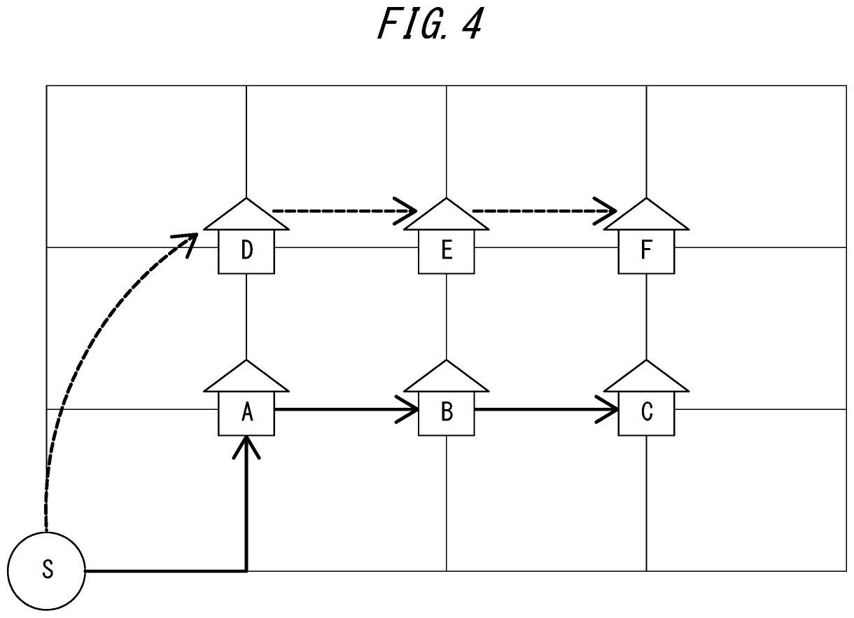

An example of the first delivery route is illustrated in FIG. 4. The first delivery route is determined by the controller 21 based on the first delivery plan. The solid lines indicate roads in a simplified manner, and each of the points indicated by symbols A to F indicates a delivery point at which the user 11 is to receive a package P. Point S indicated by the symbol S, is the point at which the vehicle 40 and the unmanned aircraft 50 start delivering the packages P. Point S is, for example, a point at which the vehicle 40 can park and start traveling via each of the delivery points in the shortest distance. In the present embodiment, when the vehicle 40 that is loaded with the unmanned aircraft 50 arrives at point S, the unmanned aircraft 50 departs from inside the vehicle 40 and carries out the air transport for each of the packages P via delivery points D, E and F, as illustrated by the dashed arrows. The vehicle 40 also departs from point S and carries out land transport for each of the packages P via delivery points A, B and C, as illustrated by the bold arrows. The vehicle 40 does not have to be parked at point S. In this case, the unmanned aircraft 50 can depart from inside the vehicle 40, when the vehicle 40 passes point S.

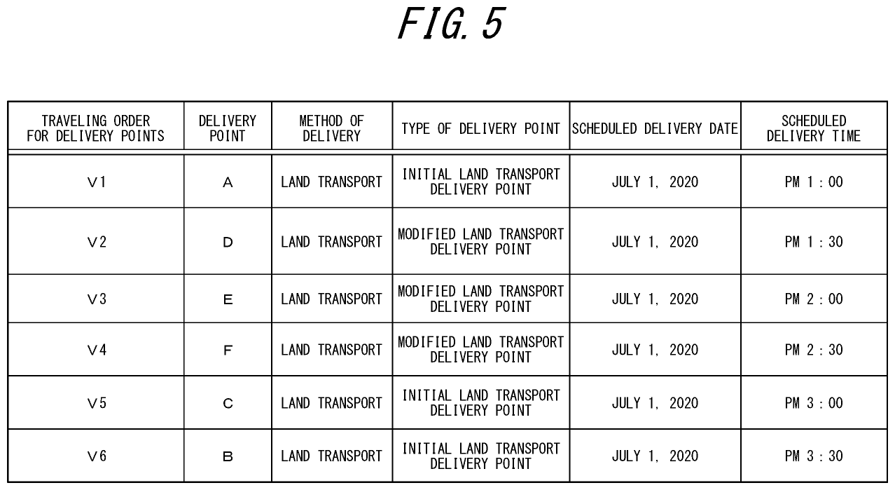

Next, an example of the second delivery plan is illustrated in FIG. 5. The second delivery plan is generated by switching the initial air transport delivery point included in the first delivery plan as a modified land transport delivery point, based on the weather information for the first delivery route that is acquired by the controller 21, as will be described in detail below. Among the information included in the second delivery plan, the delivery point is set by the controller 21 based on the position of the vehicle 40. Specifically, the controller 21 acquires positional information indicating the position of the vehicle 40 and, based on the positional information, sets the second delivery plan to include a delivery point in the first delivery route, which has not yet been traveled. In the present embodiment, among the information included in the second delivery plan, the controller 21 sets the traveling order for each of the delivery points, the scheduled delivery date, and the scheduled delivery time. The methods of delivery are all set to be land transport in the second delivery plan. In the present embodiment, the packages P are to be delivered by land transport to delivery point A, delivery point B, and delivery point C, which were initial land transport delivery points in the first delivery plan, as in the first delivery plan. At delivery point D, delivery point E, and delivery point F, which are the modified land transport delivery points, the delivery method is changed from air transport to land transport and the packages P are delivered.

The controller 21 can read the reference time from the memory and set the traveling order the delivery points so that the difference between the scheduled delivery time at an initial air transport delivery point and the scheduled delivery time at a modified land transport delivery point is equal to or less than the reference time. The “reference time” is a range within which the scheduled delivery time can be changed in a case in which the method of delivery is changed. In this example, the reference time is one hour, but it is not limited to this, and may be set freely. With reference to FIG. 5, the scheduled delivery times for delivery point D, delivery point E, and delivery point F as modified land transport delivery points are 1:30 p.m., 2:00 p.m., and 2:30 p.m. on Jul. 1, 2020, respectively. With reference to FIG. 3B, the scheduled delivery times for delivery point D, delivery point E, and delivery point F as initial air transport delivery points are 1:10 p.m., 1:20 p.m., and 1:30 p.m. on Jul. 1, 2020, respectively. In this way, the differences in scheduled delivery times between each of the initial air transport delivery points and each of the modified land transport delivery points is set to be equal to or less than the reference time of one hour.

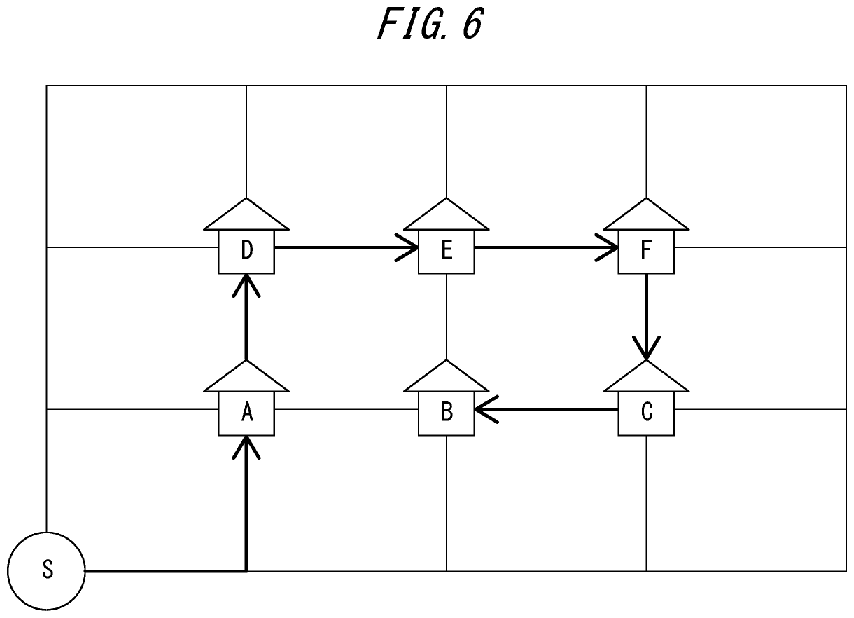

An example of the second delivery route is illustrated in FIG. 6. The second delivery route is determined by the controller 21 based on the second delivery plan. As in the first delivery route of FIG. 4, the solid lines indicate roads in a simplified manner, the points indicated by symbols A to F are delivery points, and point S is the point at which the vehicle 40 and the unmanned aircraft 50 start delivering the packages P. When the vehicle 40 that is loaded with the unmanned aircraft 50 arrives at the point S, the vehicle 40 carries out land transportation of the packages P via all the delivery points A to F, as illustrated by the bold arrows. The first delivery plan, the first delivery route, the second delivery plan, and the second delivery route are read from the memory 22 by the controller 21, and transmitted to the vehicle 40 and the unmanned aircraft 50 via the communication interface 23.

The functions of the control apparatus 20 are realized by execution of a control program according to the present embodiment by a processor corresponding to the controller 21. That is, the functions of the control apparatus 20 are realized by software. The control program causes a computer to execute the operations of the control apparatus 20, thereby causing the computer to function as the control apparatus 20. That is, the computer executes the operations of the control apparatus 20 in accordance with the control program to thereby function as the control apparatus 20.

The program can be recorded on a non-transitory computer readable medium. The non-transitory computer readable medium is, for example, a magnetic recording device, an optical disc, a magneto-optical recording medium, or a semiconductor memory. The program is distributed by sale, transfer of ownership, or rental of a portable recording medium such as a DVD or a CD-ROM on which the program is recorded. The term “DVD” is an abbreviation of digital versatile disc. The term “CD-ROM” is an abbreviation of compact disc read only memory. The program may be distributed by storing the program in a storage of a server and transferring the program from the server to another computer. The program may be provided as a program product.

The computer temporarily stores in a main memory, for example, a program recorded on a portable recording medium, or a program transferred from the server. Then, the computer reads the program stored in the main memory using a processor, and executes processes in accordance with the read program using the processor. The computer may read a program directly from the portable recording medium, and execute processes in accordance with the program. The computer may, each time a program is transferred from the server to the computer, sequentially execute processes in accordance with the received program. Instead of transferring a program from the server to the computer, processes may be executed by a so-called ASP type service that realizes functions only by execution instructions and result acquisitions. The term “ASP” is an abbreviation of application service provider. Programs encompass information that is to be used for processing by an electronic computer and is thus equivalent to a program. For example, data that is not a direct command to a computer but has a property that regulates processing of the computer is “equivalent to a program” in this context.

Some or all of the functions of the control apparatus 20 may be realized by a dedicated circuit corresponding to the controller 21. That is, some or all of the functions of the control apparatus 20 may be realized by hardware.

A configuration of the terminal apparatus 30 according to the present embodiment will be described with reference to FIG. 2. The terminal apparatus 30 includes a controller 31, a memory 32, a communication interface 33, an input interface 34, and an output interface 35.

The controller 31 includes at least one processor, at least one dedicated circuit, or a combination thereof. The processor is a general purpose processor such as a CPU or a GPU, or a dedicated processor that is dedicated to specific processing. The dedicated circuit is, for example, an FPGA or an ASIC. The controller 31 executes processes related to operations of the terminal apparatus 30 while controlling each component of the terminal apparatus 30.

The memory 32 includes at least one semiconductor memory, at least one magnetic memory, at least one optical memory, or a combination of at least two of these. The semiconductor memory is, for example, RAM or ROM. The RAM is, for example, SRAM or DRAM. The ROM is, for example, EEPROM. The memory 32 functions as, for example, a main memory, an auxiliary memory, or a cache memory. The memory 32 stores information for use in operations of the terminal apparatus 30 and information resulting from operations of the terminal apparatus 30.

The communication interface 33 includes at least one interface for communication. The interface for communication is, for example, an interface compliant with a mobile communication standard such as LTE, the 4G standard, or the 5G standard, an interface compliant with a short-range wireless communication standard such as Bluetooth®, or a LAN interface. The term “LTE” is an abbreviation of Long Term Evolution. The term “4G” is an abbreviation of 4th generation. The term “5G” is an abbreviation of 5th generation. The communication interface 33 receives information for use in operations of the terminal apparatus 30 and transmits information resulting from operations of the terminal apparatus 30.

The input interface 34 includes at least one interface for input. The interface for input is, for example, a physical key, a capacitive key, a pointing device, a touch screen integrally provided with a display, or a microphone. The input interface 34 receives a manipulation to input information for use in operations of the terminal apparatus 30. The input interface 34, instead of being included in the terminal apparatus 30, may be connected to the terminal apparatus 30 as an external input device. As the connection method, any technology such as USB, HDMI®, or Bluetooth® can be used.

The output interface 35 includes at least one interface for output. The interface for output is, for example, a display, a speaker, or a vibration motor. The display is, for example, an LCD or an organic EL display. The output interface 35 outputs information resulting from operations of the terminal apparatus 30. The output interface 35, instead of being included in the terminal apparatus 30, may be connected to the terminal apparatus 30 as an external output device. As the connection method, any technology such as USB, HDMI®, or Bluetooth® can be used.

The functions of the terminal apparatus 30 are realized by execution of a terminal program according to the present embodiment by a processor corresponding to the controller 31. That is, the functions of the terminal apparatus 30 are realized by software. The terminal program causes a computer to execute the operations of the terminal apparatus 30, thereby causing the computer to function as the terminal apparatus 30. That is, the computer executes the operations of the terminal apparatus 30 in accordance with the terminal program to thereby function as the terminal apparatus 30.

Some or all of the functions of the terminal apparatus 30 may be implemented by a dedicated circuit corresponding to the controller 31. That is, some or all of the functions of the terminal apparatus 30 may be realized by hardware.

With reference to FIGS. 1 and 2, a configuration of the vehicle 40 according to the present embodiment will be described. As illustrated in FIG. 2, the vehicle 40 includes a controller 41, a memory 42, a communication interface 43, an input interface 44, an output interface 45, and a positioner 46. As illustrated in FIG. 1, the vehicle 40 includes a vehicle body 47 that can accommodate one or more unmanned aircraft 50 and one or more packages P, and a rainfall detection device 48.

The controller 41, the memory 42, the communication interface 43, the input interface 44, the output interface 45, and the positioner 46 may each be embedded in the vehicle 40, or may be detachably provided to the vehicle 40. Some or all of the controller 41, the memory 42, the communication interface 43, the input interface 44, the output interface 45, and the positioner 46 may be embedded in a general-purpose device, such as a smartphone, a tablet terminal, a navigation device and the like, and may be communicably connected to an in-vehicle network. The controller 41, the memory 42, the communication interface 43, the input interface 44, the output interface 45, and the positioner 46 may be communicably connected to the in-vehicle network, such as a Controller Area Network (CAN).

The controller 41 includes at least one processor, at least one dedicated circuit, or a combination thereof. The processor is a general purpose processor such as a CPU or a GPU, or a dedicated processor that is dedicated to specific processing. The dedicated circuit is, for example, an FPGA or an ASIC. The controller 41 executes processing related to the operation of the vehicle 40 while controlling each component of the vehicle 40. The controller 41 executes autonomous driving or driving support based on the first delivery plan, the first delivery route, the second delivery plan, and the second delivery route that are transmitted from the control apparatus 20. The vehicle 40 departs, for example, from a warehouse or the like, being loaded with the packages P and the unmanned aircraft 50, and travels to a particular point S where the land transport and the air transport are to be started. Upon arriving at point S, the vehicle 40 and the unmanned aircraft 50 separately start delivery of the packages P. Upon completion of delivery of packages P, the vehicle 40 is again loaded with the unmanned aircraft 50, and returns to the warehouse or the like.

The memory 42 includes at least one semiconductor memory, at least one magnetic memory, at least one optical memory, or a combination of at least two of these. The semiconductor memory is, for example, RAM or ROM. The RAM is, for example, SRAM or DRAM. The ROM is, for example, EEPROM. The memory 42 functions as, for example, a main memory, an auxiliary memory, or a cache memory. The memory 42 stores data for use in an operation of the vehicle 40, and data obtained by operation of the vehicle 40. The memory 42 stores a system program, an application program, map information, the first delivery plan, the first delivery route, the second delivery plan, and the second delivery route.

The communication interface 43 includes at least one interface for communication. The interface for communication is, for example, an interface compatible with a mobile communication standard such as LTE, the 4G standard, or the 5G standard. For example, an in-vehicle communication device such as a DCM (Data Communication Module) may function as the communication interface 43. The communication interface 43 receives the data for use in an operation of the vehicle 40 and also transmits the data obtained by an operation of the vehicle 40.

The input interface 44 includes at least one interface for input. The interface for input is, for example, a physical key, a capacitive key, a pointing device, a touch screen integrally provided with a display, or a microphone. The input interface 44 accepts an operation for inputting information for use in operation of the vehicle 40. The input interface 44 may be connected to the vehicle 40 as an external input device, instead of being provided to the vehicle 40. As the connection method, any technology such as USB, HDMI®, or Bluetooth® can be used. For example, the input interface 44 may accept an operation for directly inputting the first delivery plan, the first delivery route, the second delivery plan, and the second delivery route. For example, when the vehicle 40 arrives at a delivery point and delivers a package P to the user 11, the user 11 can enter a PIN into the input interface 44. When a corresponding PIN is entered via the input interface 44, the controller 41 may open the door of the vehicle body 47 to allow the user 11 to take out the package P.

The output interface 45 includes at least one interface for output. The interface for output is, for example, a display, a speaker, or a vibration motor. The display is, for example, an LCD or an organic EL display. The output interface 45 outputs information acquired by operation of the vehicle 40. The output interface 45, instead of being included in the vehicle 40, may be connected to the vehicle 40 as an external output device. As the connection method, any technology such as USB, HDMI®, or Bluetooth® can be used.

The positioner 46 includes at least one GNSS receiver. The term “GNSS” is an abbreviation of global navigation satellite system. GNSS includes, for example, GPS, QZSS, Beidou, GLONASS, and/or Galileo. The term “GPS” is an abbreviation of Global Positioning System. The term “QZSS” is an abbreviation of Quasi-Zenith Satellite System. QZSS satellites are called quasi-zenith satellites. The term “GLONASS” is an abbreviation of Global Navigation Satellite System. The positioner 46 measures the position of the vehicle 40. The result of measurement by the positioner 46 is acquired by the controller 41 as positional information for the vehicle 40. The “positional information” is information that can identify the position of the vehicle 40, and includes, for example, the coordinates of the vehicle 40.

With reference to FIG. 1, the vehicle body 47 can accommodate one or more unmanned aircraft 50 and one or more packages P. At a rear of the vehicle body 47, a loading/unloading entrance is provided, the opening and closing of which can be controlled by the controller 41. The unmanned aircraft 50 can depart towards the delivery point from the loading/unloading entrance. The unmanned aircraft 50 can also return from the delivery point, into the vehicle body 47 through the loading/unloading entrance. Furthermore, a user 11 as a recipient may receive a package P and a user 11 as a sender may deposit a package P, via the loading/unloading entrance. In the vehicle body 47, packages P are automatically or manually loaded onto the unmanned aircraft 50. A shelf for loading packages P, a belt conveyor, a loading platform for loading packages P onto the unmanned aircraft 50, and an arm are mounted inside the vehicle body 47. When a package P is to be automatically loaded onto the unmanned aircraft 50, the following operations are controlled by the controller 41. First, the arm grasps the target package P from the shelf and places the package P on the conveyor belt. The package P is carried by the conveyor belt and proceeds to the loading platform that is connected to the end of the conveyor belt. The package P that has been carried is accommodated in the package store 51 of the unmanned aircraft 50 which is placed on the loading platform. In this way, package P is automatically loaded onto the unmanned aircraft 50. Within the vehicle body 47, additional shelves may be provided for loading a plurality of unmanned aircraft 50.

The rainfall detection device 48 is provided on the inner side of the windshield of the vehicle 40. The rainfall detection device 48 includes, for example, a light emitting part, a light receiving part, a controller connected to the light emitting part and the light receiving part, and a memory. The light emitting part irradiates measurement light, such as LED or infrared light, toward the windshield. The light receiving unit receives the measurement light reflected from the windshield, and generates a voltage corresponding to an amount of light received. As more raindrops adhere to the outside of the windshield, the measurement light tends to be emitted to the outside of the windshield with being less reflected from the windshield, thereby reducing the amount of measurement light that is received by the light receiving unit. On the other hand, as fewer raindrops adhere to the outside of the windshield, the more the measurement light is reflected from the windshield, thereby increasing the amount of measurement light received by the light receiving unit. The controller of the rainfall detection device 48 controls irradiation by the light emitting unit and also detects the voltage generated by the light receiving unit. The controller determines the rainfall amount according to the change in the detected voltage. For example, the controller determines ranges in the change in the voltage and the rainfall amount corresponding to the ranges in advance, and determines the rainfall amount according to the range to which the change in the detected voltage belongs. The controller stores the determined rainfall amount in the memory as information indicating the rainfall amount. In this way, the rainfall detection device 48 detects the rainfall amount.

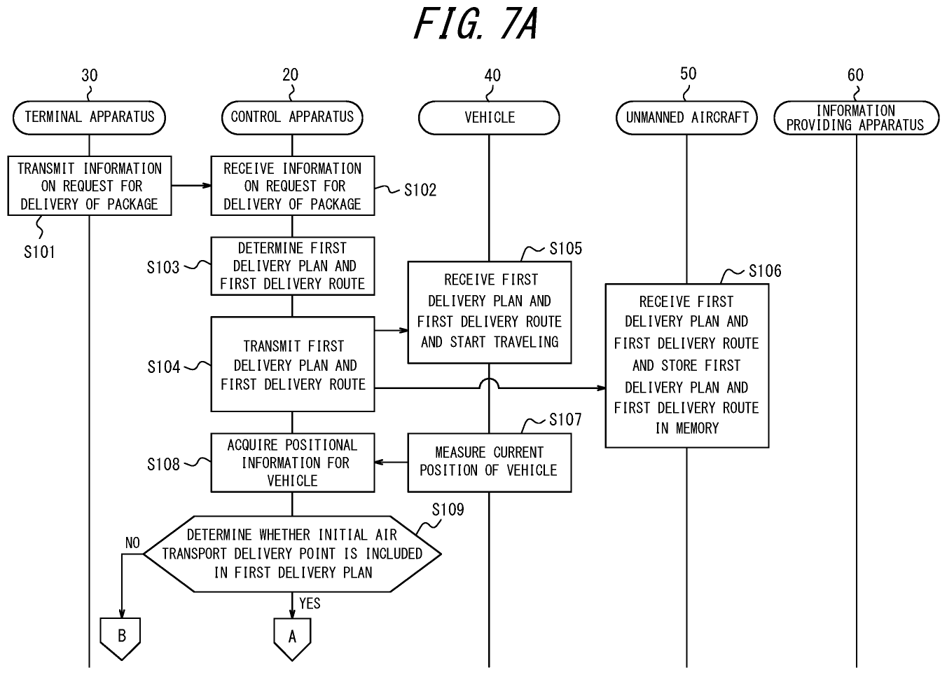

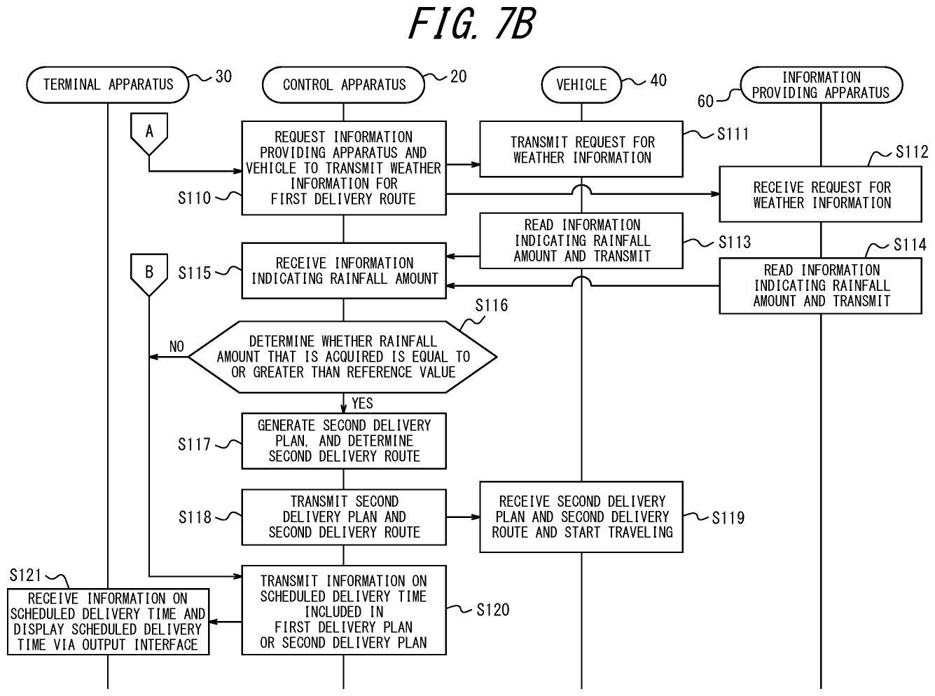

Operations of the system 10 according to the present embodiment will be described with reference to FIGS. 3A to 7B. These operations correspond to a control method according to the present embodiment. In this example, the packages P are delivered to each of the delivery points A to F, and at each delivery point users 11A to 11F receives a packages P as a recipient. In this example, users 11A to 11F use terminal apparatuses 30A to 30F, respectively. In this example, it is assumed that users 11A to 11F have entered a request for delivery of a package P to terminal apparatuses 30A to 30F, respectively. In this example, it is assumed that the unmanned aircraft 50 is loaded onto the vehicle 40. In this example, for simplicity, one of each of the terminal apparatus 30 and the unmanned aircraft 50 is illustrated in FIGS. 7A and 7B. FIGS. 7A and 7B illustrate a processing flow of the entire system 10 according to the present embodiment.

In step S101 of FIG. 7A, the controller 31 of each of the terminal apparatuses 30A to 30F transmits, via the communication interface 33, information on a request for delivery of a package P inputted by each of the users 11A to 11F, to the control apparatus 20.

In step S102, the controller 21 of the control apparatus 20 receives, via the communication interface 23, the information on the requests for delivery from each of the terminal apparatuses 30A to 30F.

In step S103, the controller 21 determines a first delivery plan and a first delivery route, based on the information on requests for delivery that is received. In this example, the controller 21 determines the first delivery plan illustrated in FIGS. 3A and 3B and determines the first delivery route illustrated in FIG. 4. The controller 21 stores the first delivery plan and the first delivery route that are determined in the memory 22. In this way, the controller 21 acquires the first delivery route.

In step S104, the controller 21 transmits, via the communication interface 23, the first delivery plan and the first delivery route that are determined to the vehicle 40 and the unmanned aircraft 50. In this example, the controller 21 transmits the first delivery plan illustrated in FIG. 3A to the vehicle 40, and transmits the first delivery plan illustrated in FIG. 3B to the unmanned aircraft 50.

In step S105, the vehicle 40 receives the first delivery plan and the first delivery route from the control apparatus 20 via the communication interface 43. In step S106, the unmanned aircraft 50 also receives the first delivery plan and the first delivery route from the control apparatus 20 via the communication interface. The controller 41 of the vehicle 40 drives the vehicle 40 toward point S in FIG. 4, so as to carry out land transport along the first delivery plan and the first delivery route that were received. The controller of the unmanned aircraft 50 stores the first delivery plan and the first delivery route that were received in the memory of the unmanned aircraft 50, so that the unmanned aircraft 50 can depart from the vehicle 40, after the vehicle 40 arrives at point S.

In step S107, the positioner 46 of the vehicle 40 measures the current position of the vehicle 40. The controller 41 of the vehicle 40 acquires the information indicating the position measured by the positioner 46, as the positional information for the vehicle 40. This example assumes that vehicle 40 is at point S in FIG. 4. The controller 41 transmits the acquired positional information to the control apparatus 20 via the communication interface 43.

In step S108, the controller 21 of the control apparatus 20 acquires the positional information for the vehicle 40 by reception thereof from the vehicle 40 via the communication interface 23. The controller 21 can constantly receive and acquire the positional information for the vehicle 40 from the vehicle 40.

In step S109, the controller 21 refers to the first delivery plan stored in the memory 22 and determines whether a delivery point for which the method of delivery is air transport, i.e., an initial air transport delivery point, is included in the first delivery plan. In a case in which an initial air transport delivery point is included, the processing of the controller 21 proceeds to step S110. In a case in which an initial air transport delivery point is not included in the first delivery plan, the processing of the controller 21 proceeds to step S120. In this example, the first delivery plan includes delivery point D, delivery point E, and delivery point F as initial air transport delivery points. Accordingly, the processing of the controller 21 proceeds to step S110.

In step S110, the controller 21 requests the vehicle 40 and the information providing apparatus 60 to transmit weather information for the first delivery route.

In step S111, the vehicle 40 receives, via the communication interface 43, the request for weather information from the control apparatus 20. In step S112, the information providing apparatus 60 also receives the request for weather information via the communication interface of the information providing apparatus 60 from the control apparatus 20.

In step S113, the controller 41 of the vehicle 40 reads the information indicating the rainfall amount from the memory of the rainfall detection device 48. In this example, the information indicating the rainfall amount that is read is 10 mm of rainfall per hour. Since the vehicle 40 is at point S on the first delivery route, the information that is read becomes information indicating the rainfall amount on the first delivery route. The controller 41 transmits the information indicating the rainfall amount that is read to the control apparatus 20 via the communication interface 43.

In step S114, the controller of the information providing apparatus 60 reads the meteorology information for the first delivery route as weather information with reference to the memory. In this example, the weather information that is read is 10 mm of rainfall per hour, as is the case with the vehicle 40. The controller of the information providing apparatus 60 transmits the information indicating the rainfall amount that is read to the control apparatus 20 via the communication interface of the information providing apparatus 60.

In step S115, the controller 21 of the control apparatus 20 receives, via the communication interface 23, information indicating the rainfall amount from the vehicle 40 and the information providing apparatus 60. In this way, the controller 21 acquires the weather information for the first delivery route. In this example, the controller 21 acquires weather information from both the information providing apparatus 60 and the vehicle 40, but the controller 21 may acquire weather information from either the information providing apparatus 60 or the vehicle 40. For example, in a case in which the controller 21 determines that the vehicle 40 is not on the first delivery route based on the positional information for the vehicle 40, the controller 21 may acquire the weather information only from the information providing apparatus 60.

In step S116, the controller 21 compares a reference value of the rainfall amount stored in the memory 22 with the rainfall amount as the weather information that is acquired, and determines whether the rainfall amount that is acquired is equal to or greater than the reference value. In a case in which the rainfall amount that is acquired is equal to or greater than the reference value, the processing of the controller 21 proceeds to step S117. In a case in which the rainfall amount that is acquired is less than the reference value, the processing of the controller 21 proceeds to step S120. In this example, the reference value of rainfall amount that is stored in the memory 22 is 5 mm per hour. In this example, the rainfall amount that is acquired is 10 mm per hour, which is above the reference value. Accordingly, the processing of the controller 21 proceeds to step S117.

In step S117, the controller 21 generates a second delivery plan in which the initial air transport delivery point in the first delivery plan is changed to a modified land transport delivery point, and determines a second delivery route. In this example, the controller 21 generates the second delivery plan in which the delivery point D, the delivery point E, and the delivery point F as the initial air transport delivery points are changed to modified land transport delivery points, respectively, and determines the second delivery route.

Specifically, the controller 21 first determines, from the positional information for the vehicle 40, delivery points on the first delivery route that have not yet been traveled. In this example, the vehicle 40 is at point S. Therefore, all of the delivery points A to F included in the first delivery route are set as information that is included in the second delivery plan. Next, the controller 21 refers to the map information and the reference time that are stored in the memory 22. The controller 21 generates a second delivery plan such that the difference between the scheduled delivery times at the initial air transport delivery points and the scheduled delivery times at the modified land transport delivery points are equal to or less than the reference time. In this example, the reference time is one hour. The controller 21 sets information on the traveling order for each of the delivery points, the scheduled delivery date and the scheduled delivery time so that the difference between the scheduled delivery times at delivery point D, delivery point E, and delivery point F as the modified land transport delivery points, and the scheduled delivery times at delivery point D, delivery point E, and delivery point F as initial air transport delivery points are equal to or less than one hour. In this way, the controller 21 generates the second delivery plan. FIG. 5 illustrates the second delivery plan that is generated. With reference to FIGS. 3B and 5, the differences between the scheduled delivery times at the initial air transport delivery points and the modified land transport delivery points are 20 minutes, 40 minutes, and 50 minutes for delivery point D, delivery point E, and delivery point F, respectively, all of which are equal to or less than the standard time. The controller 21 determines the second delivery route illustrated in FIG. 6 based on the second delivery plan that is generated. The controller 21 stores the second delivery plan and the second delivery route in the memory 22.

In step S118, the controller 21 transmits the second delivery plan and the second delivery route to the vehicle 40.

In step S119, the controller 41 of the vehicle 40 receives the second delivery plan and the second delivery route via the communication interface 43 from the control apparatus 20. The controller 41 controls each component of the vehicle 40 such that the vehicle 40 delivers packages P according to the second delivery plan and the second delivery route that are received, and causes the vehicle 40 to drive.

In step S120, the controller 21 transmits, via the communication interface 23, information on the scheduled delivery time at each delivery point to the terminal apparatus 30 of the user 11 who receives package P at the corresponding delivery point. The controller 21 refers to the memory and, in a case in which the second delivery plan exists, transmits the information on the scheduled delivery time included in the second delivery plan, or, in a case in which the second delivery plan does not exist, transmits the information on the scheduled delivery time included in the first delivery plan. The scheduled delivery time included in the second delivery plan is, i.e., the scheduled delivery time for the initial land transport delivery point or the scheduled delivery time for the modified land transport delivery point. In this example, since the second delivery plan exists, the controller 21 transmits the scheduled delivery times included in the second delivery plan illustrated in FIG. 5 to the terminal apparatuses 30A to 30F of users 11A to 11F, respectively.

In step S121, the controller 31 of the terminal apparatus 30 receives the information on the scheduled delivery time via the communication interface 33. In this example, the controller 31 of each of the terminal apparatuses 30A to 30F receives the information on the scheduled delivery time. The controller 31 displays the scheduled delivery time that is received to the user 11 via the output interface 35. In this example, each controller 31 of each of the terminal apparatuses 30A to 30F displays the scheduled delivery time.

As described above, the control apparatus 20 according to the present embodiment comprises a communication interface 23 and a controller 21 configured to acquire a first delivery route via an initial air delivery point at which a package P is to be delivered by air transport, and an initial land transport delivery point at which a package P is to be delivered by land transport, acquire weather information indicating a weather condition on the first delivery route via the communication interface 23, change the initial air delivery point to a modified land transport delivery point for which a delivery method of package P is switched to delivery by land transport, in accordance with the weather information, and determine a second delivery route via the initial land transport delivery point and the modified land transport delivery point.

The control apparatus 20 switches the delivery method of package P from air transport to land transport, according to the weather information that is acquired. Even in a case in which the weather is unsuitable for air transport, the controller 21 can still deliver package P without interruption. Thus, generation of a delivery plan for package P using unmanned aircraft 50, accounting for weather conditions, can be made easier.

As described above, according to the control apparatus 20, the air transport is carried out using an unmanned aircraft 50 and the land transport is carried out using a vehicle 40 that loads the unmanned aircraft 50. The weather information includes rainfall amount, and the controller 21 is configured to change the initial air transport delivery point to the modified land transport delivery point when the rainfall amount is equal to or greater than the reference value.

The controller 21 sets the reference value of the rainfall amount at which it is difficult for the unmanned aircraft 50 to fly in advance, and switches the delivery method of package P from air transport to land transport when the rainfall amount is equal to or greater than the reference value. Since the criteria for determining whether weather conditions are unsuitable for air transport are clarified, generation of a delivery plan for package P using unmanned aircraft 50, accounting for weather conditions, can be made easier.

As described above, the controller 21 is configured to acquire positional information indicating a position of the vehicle 40 and determines the second delivery route based on the positional information.

Even while the vehicle 40 is traveling toward the delivery point, the controller 21 can flexibly determine the second delivery route so that the vehicle 40 can head to the delivery point at which delivery was scheduled to have been done by the unmanned aircraft 50. Thus, generation of a delivery plan for package P using unmanned aircraft 50, accounting for weather conditions, can be made easier.

As described above, the communication interface 23 communicates with the vehicle 40, and the controller 21 acquires positional information from the vehicle 40 via the communication interface 23.

By acquiring positional information from the vehicle 40, the controller 21 can always determine the exact position of the vehicle 40. Thus, generation of a delivery plan for package P using unmanned aircraft 50, accounting for weather conditions, can be made easier.

As described above, the communication interface 23 is configured to communicate with an information providing apparatus 60 that stores meteorology information, and the controller 21 is configured to acquire the weather information from the information providing apparatus 60 via the communication interface 23.

By acquiring weather information that is constantly observed by the information providing apparatus 60, the controller 21 can determine whether the weather is unsuitable for air transport based on more accurate weather information. Thus, generation of a delivery plan for package P using unmanned aircraft 50, accounting for weather conditions, can be made easier.

As described above, the controller 21 is configured to determine the second delivery route such that the difference between a scheduled delivery time at the initial air transport delivery point and a scheduled delivery time at the modified land transport delivery point is equal to or less than a reference time.

The controller 21 can determine the second delivery route that does not significantly delay the scheduled delivery time of package P even in a case in which the delivery method is switched from air transport to land transport. Since the scheduled delivery time is not significantly delayed, it becomes easier for the user 11 to receive the package P at the delivery point at the scheduled delivery time as changed. Generation of a delivery plan for package P using unmanned aircraft 50, accounting for weather conditions, can be made easier.

As described above, the communication interface 23 is configured to communicate with a terminal apparatus 30 of a user 11 who receives package P at the initial land transport delivery point or the modified land transport delivery point that is traveled in the second delivery route. The controller 21 is configured to transmit, via the communication interface 23, information indicating a scheduled delivery time at the initial land transport delivery point or a scheduled delivery time at the modified land transport delivery point to the terminal apparatus 30 of the user 11.

The terminal apparatus 30 can receive the scheduled delivery time as changed, and notify the user 11 via the output interface 35. The user 11 can understand the scheduled delivery time, which makes it easier for the user 11 to receive package P at the initial land transport delivery point or the modified land transport delivery point. Thus, generation of a delivery plan for package P using unmanned aircraft 50, accounting for weather conditions, can be made easier.

### Second Embodiment

Hereinafter, differences between the first embodiment and the present embodiment will be described.

Since the configuration of the system 10, the control apparatus 20, the terminal apparatus 30, the vehicle 40, the unmanned aircraft 50, and the information providing apparatus 60 according to the present embodiment are the same as those of the first embodiment, a description thereof is omitted.

In the present embodiment, the controller 21 generates the second delivery plan by setting the traveling order for each of the delivery points, so that the initial land transport delivery point and the modified land transport delivery point are traveled in an order of earliest to latest of scheduled delivery times at the initial land transport delivery points and the scheduled delivery times at the initial air transport delivery points, which are in the first delivery plan. The second delivery plan and the second delivery route according to the present embodiment are stored in the memory 22 of the control apparatus 20, as in the case of the first embodiment.

The operation of the system 10 of the present embodiment differs from that of the first embodiment only in step S117 of FIG. 7B.

In step S117, the controller 21 of the control apparatus 20 generates the second delivery plan and determines the second delivery route. As in the case of the first embodiment, the controller 21 sets all of the delivery points A to F included in the first delivery route as information that is included in the second delivery plan. Next, the controller 21 refers to the first delivery plan stored in the memory 22 and generates the second delivery plan by setting the traveling order for each of the delivery points, so that the initial land transport delivery point and the modified land transport delivery point are traveled in the order of earliest to latest of scheduled delivery times for the initial land transport delivery points and the scheduled delivery times for the initial air transport delivery points, which are in the first delivery plan. In this example, from FIGS. 3A and 3B, when the initial land transport delivery points and the initial air transport delivery points are arranged in the order of earliest to latest of the scheduled delivery times, the order is delivery point A, delivery point D, delivery point E, delivery point B, delivery point F, and delivery point C. The controller 21 sets the order as the traveling order for each of the delivery points, and sets each of the scheduled delivery dates and scheduled delivery times based on the traveling order. In this way, the controller 21 generates the second delivery plan and determines the second delivery route. The controller 21 stores the second delivery plan and the second delivery route in the memory 22.

As described above, the controller 21 determines the second delivery route so that the initial land transport delivery points and the modified land transport delivery points are traversed in the order of the earliest to latest of the scheduled delivery times for the initial land transport delivery points and the scheduled delivery times for the initial air transport delivery points.

The controller 21 can quickly determine the second delivery route by simply setting the traveling order for each of the delivery points as the order of the earliest to latest of the scheduled delivery times that are included in the first delivery plan. Thus, generation of a delivery plan for packages P using unmanned aircraft 50, accounting for weather conditions, can be made easier.

(Variation 1)

As a variation of the present embodiment, the system 10 may further comprise a sensor vehicle 80, which is a different vehicle from the vehicle 40 and travels on the first delivery route. In present variation, the system 10 includes one or more sensor vehicles 80. The sensor vehicle 80 may be a special vehicle dedicated to the system 10, or it may be a general vehicle. The sensor vehicle 80 includes, for example, a controller, a communication interface, a memory, and a rainfall detection device. Since the configuration of the rainfall detection device is the same as that of the rainfall detection device 48 in the vehicle 40, a description thereof is omitted. In present variation, the controller of the sensor vehicle 80 reads information indicating the rainfall amount from the memory of the rainfall detection device. Since the sensor vehicle 80 is traveling on the first delivery route, the information that is read becomes information indicating the rainfall amount on the first delivery route. The controller of the sensor vehicle 80 transmits, via the communication interface, the information indicating the rainfall amount that is read to the control apparatus 20. The controller 21 of the control apparatus 20 receives, via the communication interface 23, information indicating the rainfall amount from the sensor vehicle 80. In this way, the controller 21 acquires weather information for the first delivery route from the sensor vehicle 80.

As described above, the communication interface 23 is configured to communicate with the vehicle 40 that comprises a rainfall detection device 48 or with a sensor vehicle 80 that comprises a rainfall detection device. The controller 21 is configured to acquire, via the communication interface 23, information indicating rainfall amount on the first delivery route that is detected by the rainfall detection device 48 of the vehicle 40 or the rainfall detection device of the sensor vehicle 80.

By acquiring weather information from the vehicle 40 or the sensor vehicle 80 on the first delivery route, the controller 21 can determine whether the weather is unsuitable for air transport based on more accurate weather information. Thus, generation of a delivery plan for packages P using unmanned aircraft 50, accounting for weather conditions, can be made easier.

(Variation 2)

As a variation of the present embodiment, the controller 21 of the control apparatus 20 acquires a change request from user 11 for the scheduled delivery time that is included in the second delivery plan, and can generate the second delivery plan again based on the change request. In the present variation, when the controller 31 of the terminal apparatus 30 displays the scheduled delivery time included in the second delivery plan to the user 11 in step S121 of FIG. 7B, the controller 31 also receives a change request from user 11 for the scheduled delivery time. When the change request is inputted by the user 11 via the input interface 34, the controller 31 transmits the information indicating the inputted change request to the control apparatus 20 via the communication interface 33. The control apparatus 20 acquires the change request by receiving the information that is sent from the terminal apparatus 30. The control apparatus 20 generates the second delivery plan again based on the change request that is acquired, and determines again the second delivery route based on the second delivery plan.

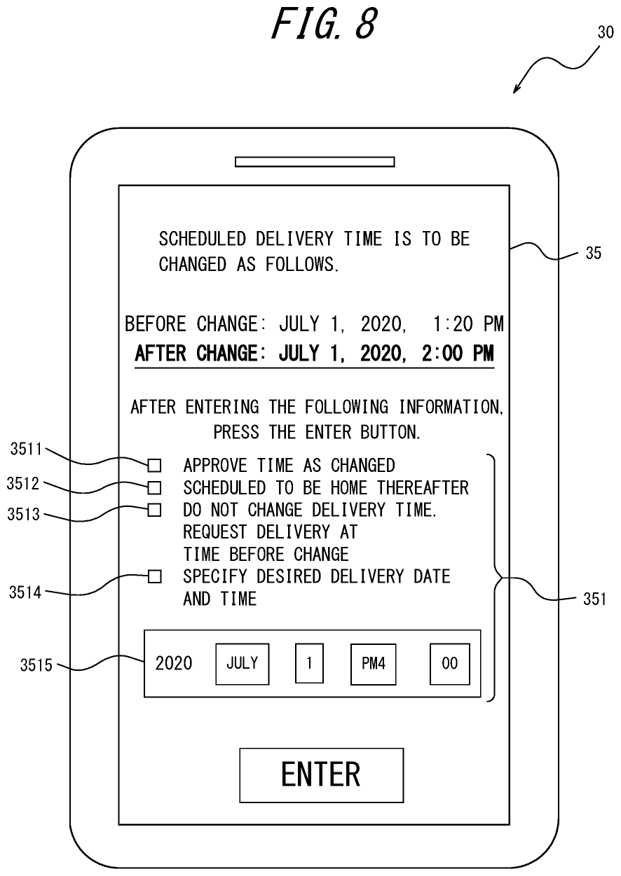

An example of a screen displayed by the output interface 35 of the terminal apparatus 30 in the present variation is illustrated in FIG. 8. The user 11 understands the scheduled delivery time, as changed, that is displayed at the top of the screen. The user 11 enters a check in a check box corresponding to an action input field 351. In FIG. 8, checkbox 3511 is checked when the user 11 approves the scheduled delivery time that is displayed. Checkbox 3512 is checked when the user 11 can receive package P at any time after the point at which the user 11 enters a check in the checkbox 3512. That is, checkbox 3512 is checked in a case in which the user 11 approves an adjustment to a time other than the scheduled delivery time that is displayed. Checkboxes 3513 and 3514 are checked by the user 11 in cases in which the user 11 wishes to change the scheduled delivery time that is displayed. Checkbox 3513 is checked in a case in which the user 11 wishes to revert to the scheduled delivery time before the change. In a case in which the user 11 enters a check in the checkbox 3514, the user 11 further enters a desired scheduled delivery time in time input field 3515. The terminal apparatus 30 transmits the information entered in the action input field 351 to the control apparatus 20.

The controller 21 of the control apparatus 20 acquires the change request for the scheduled delivery time by receiving the information entered in the checkbox 3513 and the checkbox 3514. The controller 21 also acquires an approval response for the scheduled delivery time by receiving the information entered in the checkbox 3511, and acquires an approval response for adjustment of the scheduled delivery time by receiving the information entered in the checkbox 3512. Based on the change request, the approval response for the scheduled delivery time, and the approval response for the adjustment of the scheduled delivery time that are acquired, the controller 21 again generates the second delivery plan and determines the second delivery route. The controller 21 transmits the second delivery plan and the second delivery route that are generated again to the vehicle 40 via the communication interface 23. The vehicle 40 receives the second delivery plan and the second delivery route that are generated again, and delivers packages P via the delivery points according to the second delivery route.

As described above, the controller 21 is configured to acquire, via the communication interface 23, a change request from the terminal apparatus 30 for the scheduled delivery time at an initial land transport delivery point or the scheduled delivery time at a modified land transport delivery point, and determine, based on the change request, the second delivery route via the initial land transport delivery point or the modified land transport delivery point.

The control apparatus 20 generates again the second delivery route that reflects the change request for the scheduled delivery time from user 11, thereby making it easier for the user 11 to receive package P at the initial land transport delivery point or the modified land transport delivery point. Thus, generation of a delivery plan for packages P using unmanned aircraft 50, accounting for weather conditions, can be made easier.

The present disclosure is not limited to the embodiment described above. For example, a plurality of blocks described in the block diagrams may be integrated, or a block may be divided. Instead of executing a plurality of steps described in the flowcharts in chronological order in accordance with the description, the plurality of steps may be executed in parallel or in a different order according to the processing capability of the apparatus that executes each step, or as required. Other modifications can be made without departing from the spirit of the present disclosure.

1. A control apparatus comprising:
a communication interface; and
a controller configured to:
acquire a first delivery route via an initial air delivery point at which a package is to be delivered by air transport, and an initial land transport delivery point at which a package is to be delivered by land transport;
acquire weather information indicating a weather condition on the first delivery route via the communication interface;
change the initial air delivery point to a modified land transport delivery point for which a delivery method of the package is switched to delivery by land transport, in accordance with the weather information; and
determine a second delivery route via the initial land transport delivery point and the modified land transport delivery point.

2. The control apparatus according to claim 1, wherein
the air transport is carried out using an unmanned aircraft and the land transport is carried out using a vehicle that loads the unmanned aircraft,
the weather information includes a rainfall amount, and
the controller is configured to change the initial air transport delivery point to the modified land transport delivery point when the rainfall amount is equal to or greater than a reference value.

3. The control apparatus according to claim 2, wherein the controller is configured to acquire positional information indicating a position of the vehicle and determine the second delivery route based on the positional information.

4. The control apparatus according to claim 3, wherein the communication interface is configured to communicate with the vehicle, and the controller is configured to acquire the positional information from the vehicle via the communication interface.

5. The control apparatus according to claim 2, wherein
the communication interface is configured to communicate with an information providing apparatus that stores meteorology information, and
the controller is configured to acquire the weather information from the information providing apparatus via the communication interface.

6. The control apparatus according to claim 2, wherein
the communication interface is configured to communicate with the vehicle that comprises a rainfall detection device or with a sensor vehicle that comprises a rainfall detection device, and
the controller is configured to acquire, via the communication interface, information indicating rainfall amount on the first delivery route that is detected by the rainfall detection device of the vehicle or the rainfall detection device of the sensor vehicle.

7. The control apparatus according to claim 1, wherein the controller is configured to determine the second delivery route so that the initial land transport delivery point and the modified land transport delivery point are traveled in an order of earliest to latest of a scheduled delivery time at the initial land transport delivery point and a scheduled delivery time at the initial air transport delivery point.

8. The control apparatus according to claim 1, wherein the controller is configured to determine the second delivery route such that the difference between a scheduled delivery time at the initial air transport delivery point and a scheduled delivery time at the modified land transport delivery point is equal to or less than a reference time.

9. The control apparatus according to claim 1, wherein
the communication interface is configured to communicate with a terminal apparatus of a user who receives the package at the initial land transport delivery point or the modified land transport delivery point that is traveled in the second delivery route, and
the controller is configured to transmit, via the communication interface, information indicating a scheduled delivery time at the initial land transport delivery point or a scheduled delivery time at the modified land transport delivery point to the terminal apparatus of the user.

10. The control apparatus according to claim 9, wherein the controller is configured to:
acquire, via the communication interface, a change request from the terminal apparatus for the scheduled delivery time at the initial land transport delivery point or the scheduled delivery time at the modified land transport delivery point; and
determine, based on the change request, the second delivery route via the initial land transport delivery point or the modified land transport delivery point.

11. A system comprising:
the control apparatus according to claim 2; and
the vehicle.

12. A non-transitory computer readable medium storing a program configured to cause a computer comprising a communication interface to execute operations, the operations comprising:
acquiring a first delivery route via an initial air delivery point at which a package is to be delivered by air transport, and an initial land transport delivery point at which a package is to be delivered by land transport;
acquiring weather information indicating a weather condition on the first delivery route via the communication interface;
changing the initial air delivery point to a modified land transport delivery point for which a delivery method of the package is switched to delivery by land transport, in accordance with the weather condition; and
determining a second delivery route via the initial land transport delivery point and the modified land transport delivery point.

13. The non-transitory computer readable medium according to claim 12, wherein
the air transport is carried out using an unmanned aircraft and the land transport is carried out using a vehicle that loads the unmanned aircraft,
the weather information includes rainfall amount, and
the operations further comprise changing the initial air transport delivery point to the modified land transport delivery point when the rainfall amount is equal to or greater than a reference value.

14. The non-transitory computer readable medium according to claim 13, wherein the operations further comprise acquiring positional information indicating a position of the vehicle and determining the second delivery route based on the positional information.

15. The non-transitory computer readable medium according to claim 14, wherein the operations further comprise:
communicating with the vehicle; and
acquiring the positional information from the vehicle via the communication interface.

16. The non-transitory computer readable medium according to claim 13, wherein the operations further comprise:
communicating with an information providing apparatus that stores meteorology information; and
acquiring the weather information from the information providing apparatus via the communication interface.

17. The non-transitory computer readable medium according to claim 13, wherein the operations further comprise:
communicating with the vehicle that comprises a rainfall detection device or with a sensor vehicle that comprises a rainfall detection device; and
acquiring, via the communication interface, information indicating rainfall amount on the first delivery route that is detected by the rainfall detection device of the vehicle or the rainfall detection device of the sensor vehicle.

18. The non-transitory computer-readable medium according to claim 12, wherein the operations further comprise determining the second delivery route so that the initial land transport delivery point and the modified land transport delivery point are traveled in an order of earliest to latest of a scheduled delivery time at the initial land transport delivery point and a scheduled delivery time at the initial air transport delivery point.

19. The non-transitory computer-readable medium according to claim 12, wherein the operations further comprise determining the second delivery route such that the difference between a scheduled delivery time at the initial air transport delivery point and a scheduled delivery time at the modified land transport delivery point is equal to or less than a reference time.

20. The non-transitory computer-readable medium according to claim 12, wherein the operations further comprise:
communicating with a terminal apparatus of a user who receives the package at the initial land transport delivery point or the modified land transport delivery point that is traveled in the second delivery route; and
transmitting, via the communication interface, information indicating a scheduled delivery time at the initial land transport delivery point or a scheduled delivery time at the modified land transport delivery point to the terminal apparatus of the user.
